(19) United States
(12) Patent Application Publication
(10) Pub. No.: US 2004/0178243 A1
(43) Pub. Date: Sep. 16, 2004

(54) Cargo and board transportation system

(76) Inventors: Howard C. Clark, Kailua-Kona, HI (US); Kenneth Y. Sasaki, (US)

Correspondence Address: Howard C. Clark, 73-4327 Malu Place, Kailua-Kona, HI, 96740, US

(21) Appl. No.: 10/637,967

(22) Filed: Aug. 8, 2003

Related U.S. Application Data
(63) Continuation-in-part of application No. 10/387,676, filed on Mar. 12, 2003.

(51) Int. Cl. B60R 9/04

(52) U.S. Cl. 224/314

(57) ABSTRACT

The “Cargo and Board Transportation System” (“CBTS”) is a multi-purpose, reusable storage and transportation container with a built-in vehicular roof rack and attachment system. A CBTS comprises an exterior layer (6); a zippered opening (11); at least one anterior soft rack (18) bonded to the exterior layer (6) and equipped with a vehicle strapping system (3, 3′) that traverses the soft rack and is bonded to the exterior layer (6) and/or the anterior soft rack (18); and at least one posterior soft rack (19) bonded to the exterior layer (6) and equipped with a vehicle strapping system (3, 3′) that traverses the soft rack and is bonded to the exterior layer (6) and/or the posterior soft rack (19). Universal clips (14) and universal clip webbing (20), and buddy system straps (2, 2′), are desirable to enable load compression and joining other cargo bags to a first CBTS.

### CROSS-REFERENCE TO RELATED APPLICATIONS

This application is a Continuation-In-Part, and claims the benefit of U.S. patent application Ser. No. 10/387,676, entitled “Board Transportation System,” filed Mar. 12, 2003, by the present inventors. This application also claims benefit of PCT International Application PCT/US/03/22098 entitled “Cargo & Board Transportation System” filed Jul. 12, 2003 by the present inventors.

### BACKGROUND OF THE INVENTION

1. Technical Field

A surfboard is principally made of fiberglass and foam. It is a very fragile piece of equipment and can be damaged easily, especially by minor impacts to its bottom surface that produce dents and “dings”, and corresponding reductions in hydrodynamic performance. Fiberglass is sensitive to heat and stress. The fins on a surfboard are also very sensitive to stress and can snap with ease. A surfboard can range from 4 to 10 feet long and can be as wide as 22 to 36 inches. Some boards, mainly “longboards” (8-10 feet in length) can weigh up to 25 pounds. Most “shortboards” (5-7 feet in length) weigh less than 10 pounds. The length and fragility of surfboards makes them difficult to transport without damage. Surfboards illustrate a class of cargo for which existing reusable means of end-user packaging for storage and transportation are inadequate.

A surfer has various needs for safekeeping a surfboard during both storage and travel. One commercially available product for storage and travel is the “board bag.” There are many different types of board bags. Traditionally, board bags have been constructed using materials like cotton, padded nylon, and hard plastic. Some bags can be as simple as a cloth material that is pulled over the board to keep it clean. Other bags are padded, heat resistant, and have carrying provisions (like a handle or a shoulder strap), but most are not integrated with a means for wheeled or vehicular transport. Board bags range in size and material depending on the surfboard size and traveling needs. Some board bags have room for multiple boards, and various zippered compartments for storing other objects; others have hard covers for traveling by air.

When a surfer is traveling by car, the board (exposed, or inside a board bag) can be stored on top of the car using a surfboard rack. There are various types of “car racks”, but the most common racks for cars are usually either “hard racks” (permanent metal racks attached to a vehicle's roof) or “soft racks” (a portable padded rack system constructed with two separate pieces of soft foam material designed to provide space between a vehicle's roof and the load, and to provide protection for the vehicle's roof). Nearly all existing soft rack products are used by first strapping the rack system to the vehicle's roof using straps through the interior of the vehicle, and then strapping the board(s) to the top of the soft rack using additional strapping.

In the past, storing and transporting a surfboard has meant acquiring different products: a board bag, a vehicle roof rack system, and straps with which to attach the board bag to the vehicle or to the roof rack system.

2. Description of the Related Art

Surfboards are essentially airfoils that generate high lift when placed skeg-side up on roof racks during transport. Recognizing the risk of separation of boards from soft racks while being transported on highways, a few inventors have created board bags that have attachable strapping systems in order to secure the board bag directly to the vehicle. U.S. Pat. No. 4,793,535 to Johnson (1988) discloses a board bag that may be used as a back-pack and as a roof-top bag for transporting a surfboard by vehicle. U.S. Pat. No. 6,230,951 to Anderson (2001) discloses a board “bag for storing, carrying, or holding on top of a vehicle a surfboard, wakeboard, or snowboard that protects stores, displays, and travels all in one comprehensive product.” However, all the board bags heretofore known suffer from a number of disadvantages:

a) Johnson's design utilizes a “special rack-attachment adapter by which the sack carrier may be converted into a rack for mounting to the roof of an automobile”; however, this design is dependent on the vehicle having a “roof gutter”, which is not only cumbersome to attach, but, limits the invention's use to vehicles (almost entirely older models) that have a roof gutter.

b) Johnson's “special rack-attachment adapter” consists of several independent pieces that must be separately stored when not in use and attached to the unit for use. These “adapter” pieces are not permanently attached to the bag, and, are therefore subject to loss; loss of one piece prevents use of the remaining system.

c) Anderson's invention, similar to Johnson's, also utilizes a strapping system that is not permanently attached to the unit. Since the pieces are independent of the unit, loss of one or more straps prevents use of the remaining system.

d) Additionally, both Anderson's and Johnson's design straps the bag down flat against the vehicle roof. Johnson uses the term “rack”, but neither his design nor Anderson's design displaces the bag above the vehicle roof. This design creates a serious and large point of contact for both heat, which can damage the board being transported, and wear and tear to the automobile by rubbing on the vehicle's roof paint.

e) Neither Johnson's nor Anderson's design allow for additional board (or other cargo) bags to be attached to their respective design without the purchase and use of additional strapping material. Moreover, Johnson's design does not provide loops, rings, or similar points of attachment for additional bags.

The existing art has failed to address the need to displace an integrated “bag/rack” system above a vehicle roof during transport, the need to couple more than one bag, and the need to accommodate other types of cargo, using built-in components. None of the existing art has recognized the need or motivation to have such functionality, much less suggested a solution or expectation of success. What is needed is an improved cargo bag, which incorporates in a single unit (without the use of any attachments) a protective bag, a vehicle rack and attachment system, alternate embodiments for other types of cargo (e.g., surfboards, snowboards, wave boards, golf bags, hockey equipment, diving equipment, camping equipment, “stick sports” equipment such as that for baseball, softball, lacrosse, and fencing, other sports equipment, luggage, watercraft such as kayaks, canoes, and rowing shells, general cargo, etc.) and additional strapping to securely attach multiple bags together (even of different types, e.g., a surfboard bag and a camping equipment bag) without the need to retain or purchase any additional straps or fastening equipment. Surfboards, snowboards, wave boards, and similar type equipment are collectively called “sports boards” herein. In reference to the present invention, the term “bag” is used interchangeably with the term “container”; in some embodiments, e.g., camping equipment, the embodiment shape in use is more box-like than bag-like. The present invention includes all of the necessary components required to conveniently and safely store and transport sports board by hand, on foot, on airlines, or on a motor vehicle in a single self-contained unit. Alternate embodiments of the invention can be used for cargo other than sports boards.

### OBJECTS AND ADVANTAGES OF THE INVENTION

Several objects and advantages of the present invention are:

(a) to provide a roof-top cargo bag that is safely secured by strapping through the passenger compartment of vehicles, e.g., passenger cars and SUVs, regardless of roof design;

(b) to provide a cargo bag that, in itself, is a transportation unit including a vehicular “soft” roof rack system in one self-contained and permanently attached unit;

(c) to provide a cargo bag that contains zippered pouches in which to store the tie-down straps;

(d) to provide a cargo bag that has polyurethane foam sections, or the like, sewn or otherwise bonded into the bag to provide separation between the vehicle roof and the bag contents;

(e) to provide a cargo bag which includes built-in, adjustable “buddy system” straps (normally stored in zippered compartments) to allow for additional cargo bags to be securely strapped onto a first roof-top cargo bag;

(f) to provide a board bag which utilizes a universal clipping system that allows multiple cargo bags, including different types of cargo bags, to be clipped together for hand carry, vehicular, air, or other transportation;

(g) to provide a sports board bag that accommodates, depending on the model, multiple boards within one single bag;

(h) to provide a cargo bag with a built-in wheel and carrying handle for ease in transport;

(i) to provide a cargo bag which has a handle for hand carrying;

(j) to provide a cargo bag which has a protective cushion for its contents;

(k) to provide a cargo bag which is covered in a Ultraviolet Protection Factor rated material, or the like;

(l) to provide a cargo bag which offers an optional woven steel or like material within the exterior cover and strapping system as a theft-deterrent;

(m) to provide a cargo bag which uses non-corrosive zippers for easier opening of compartments and for attaching locks;

(n) to provide a cargo bag that offers various pockets sewn into the bag to store sports accessories or personal items;

(o) to provide a cargo bag in which the contents of the bag may be removed without taking the bag off of the vehicle;

(p) to provide a cargo bag that can be clipped to other similar cargo bags using the universal clips; and

(q) to provide a coordinated series of cargo bags for all types of board sports, e.g., surfboards, snowboards, snow skis, water skis, wake boards, wind surfers, kite surfers, canoes, kayaks, and the like, and for other types of cargo, both specific (camping equipment, musical equipment) and general (boxed goods).

Normally, only size modifications are required for each embodiment of the invention designed for a different type of cargo; embodiments intended for use with some types of cargo require the use of reinforcement in the ventral portion of the bag (the portion closest to the vehicle roof when the bag is mouhted on a vehicle roof; the dorsal portion is that portion of the mounted bag most distant from the vehicle roof). Still further objects and advantages will become apparent from a consideration of the ensuing description and drawings.

### SUMMARY OF THE INVENTION

The “Cargo and Board Transportation System” invention, referred to herein as the “CBTS”, and sometimes as “the cargo bag”, is a multi-purpose, reusable storage and transportation container with a built-in vehicular roof rack and attachment system that can incorporate optional elements to enhance versatility, convenience and safety. The invention title, “Cargo and Board Transportation System”, is not intended to, and does not, limit use of the invention to sports boards or a specific type of cargo. The main body of the CBTS, consisting essentially of the container formed by the exterior layer, is called herein the “container body”. The CBTS enables a user to store and transport sports equipment, such as surfboards, snowboards, water skis, snow skis, wake boards, wind surfboards, kite surfboards, and other types of cargo, by hand, vehicle, foot, or air.

The physical structure of a preferred embodiment of the cargo bag consists of an insulated bag made of durable, non-abrasive fabric or like material materials, preferably with an Ultraviolet Protection Factor (“UPF”) rating of 15 or higher under the UPF rating system of the Australian Radiation Protection and Nuclear Safety Agency (www.arpansa.gov.au/uvrg/info7.htm#stdslist). All straps and webbing used in the CBTS are also preferably rated UPF 15 or higher. The ventral portion of the CBTS includes a built-in vehicle “soft rack” system. Four adjustable vehicle straps, concealed in zipper pouches on the container body until needed, can be used to attach the CBTS to a vehicle by routing the straps through the passenger cabin of the vehicle, coupling the straps inside the passenger cabin using the supplied couplers, and tensioning the straps. The main compartment of the CBTS allows for storage of one or more sports boards (in an embodiment for sports boards) and has a zippered opening for access to the main compartment. The optional “buddy system” straps are concealed in the zippered strap storage compartments on the container body of a CBTS until needed, and allow the user to safely strap multiple CBTSs together for hand, automobile, airline, or other transportation. Additional optional elements include, but are not limited to: (a) one or more large exterior pockets for storage of personal items or accessories, (b) a wheel and handle system (and optional dolly attachment for larger or heavily loaded bags) to allow the bag to be rolled, instead of carried, (d) anti-theft devices, and (e) universal clips or fasteners that allow one more cargo bags to be securely fastened together (in addition to, or in lieu of, using buddy system straps).

### BRIEF DESCRIPTION OF THE DRAWINGS

The invention will be more readily understood with reference to the accompanying drawings, wherein:

FIG. 1 shows a general bottom (ventral) view of the CBTS with all straps extended out of the CBTS.

FIG. 2 shows a short axis, cross-sectional view—along the midline of the anterior soft rack portion of the CBTS.

FIG. 3 shows a top (dorsal) view of the CBTS with all straps stored inside the CBTS.

FIG. 4 shows a long axis, cross-sectional view along the midline of the CBTS.

FIG. 5 shows multiple CBTSs attached to a vehicle.

FIG. 6 shows universal clips extended from the CBTS.

FIG. 7 shows a detail of a preferred universal clip (a carabiner).

FIG. 8 shows a streamlined, high-sided CBTS, dimensioned to reduce wind loading.

FIG. 9 shows a CBTS dimensioned for kayaks, canoes, and rowing shells, with stabilization straps, roof-top, with strapless additional soft racks.

FIG. 10 shows a side view of a high-sided CBTS, with stabilization straps, mounted on a vehicle rooftop.

FIG. 11 shows a front view of a high-sided CBTS, with stabilization straps, mounted on a vehicle rooftop.

FIG. 12 shows a side view of four stacked CBTSs, rooftop mounted, two layers of two CBTSs per layer.

FIG. 13 shows a front view of four stacked CBTSs, rooftop mounted, two layers of two CBTSs per layer.

FIG. 14 shows a side view of the posterior portion of a CBTS with a dolly attachment.

FIG. 15 shows a detail view of the dolly attachment of FIG. 14.

FIG. 16 shows a user wheeling (using dolly attachment) a kayak CBTS on the ground.

### REFERENCE NUMERALS IN THE DRAWINGS ARE

1. compressible core of a soft rack

2. optional buddy system strapping

3. vehicle strapping system

4. zippered compartment for strapping and universal clip system storage

5. optional carrying handle for hand carry

6. exterior layer

7. male/female coupler

8. optional wheel

9. optional carrying handle

10. optional accessory storage pocket

11. zippered opening for access to main compartment

12. optional protective cushioning

13. optional interior lining

14. optional universal clip

15. optional soft rack backing

16. optional accessory storage pocket zipper

17. main compartment

18. anterior soft rack

19. posterior soft rack

20. optional universal clip webbing

21. optional soft rack shell

22. optional posterior reinforcement with dolly attachment

23. optional stabilization strap

24. optional strapless soft rack

25. optional terminal universal clip

### DETAILED DESCRIPTION OF THE PREFERRED EMBODIMENTS

In the following description, which is illustrative only and not limiting, reference numerals will be used to refer to corresponding elements in the different figures of the drawings.

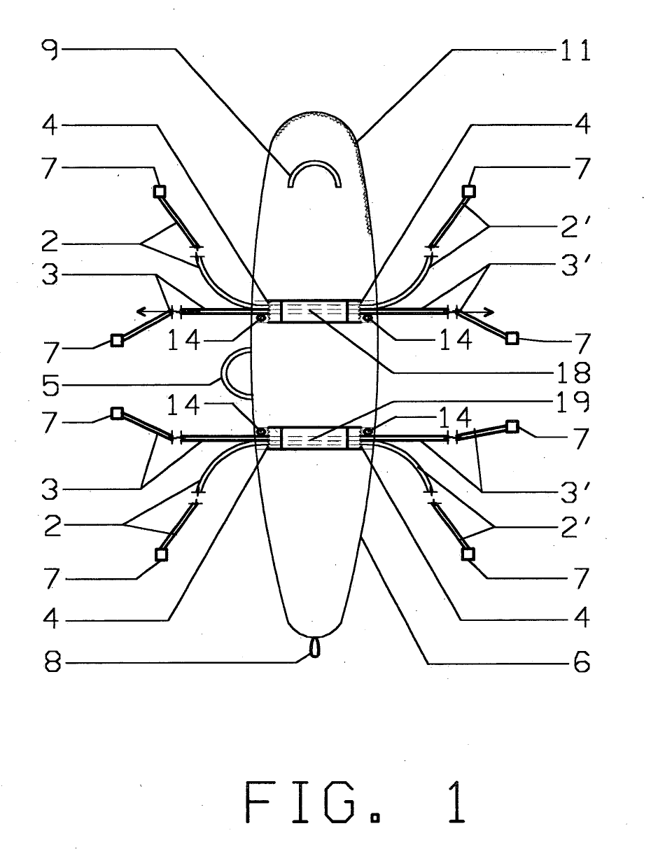

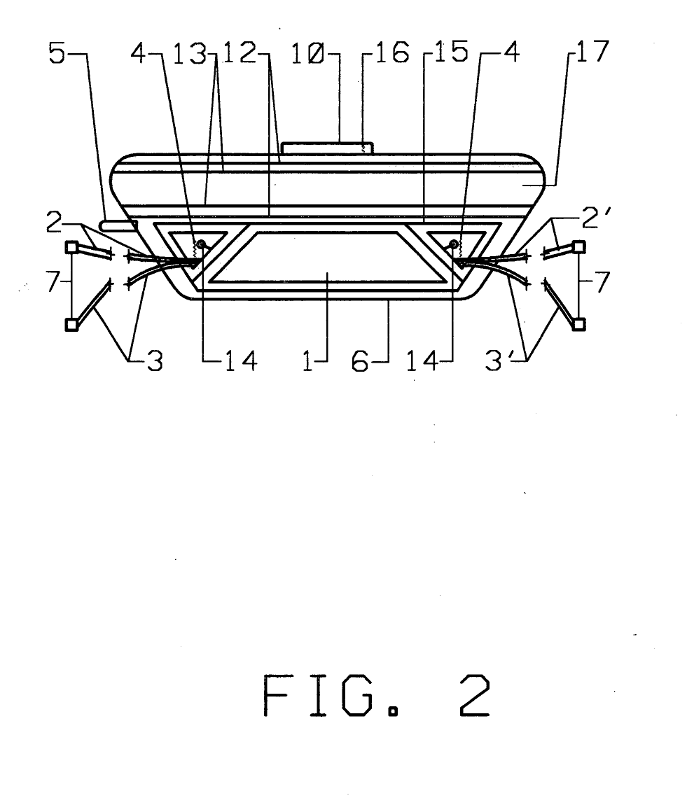

FIG. 1 (bottom or ventral view) and FIG. 2 (short axis cross section through the anterior soft rack (18)) show a preferred embodiment of the CBTS for use with sports boards. The main compartment (17) is used as a point of radial reference in FIG. 2. The meaning herein of the terms “sewn” and “bonded” include sewing, welding, gluing, riveting, and other methods known in the art of fastening or bonding pieces of woven and/or non-woven flexible materials together. The meaning herein of the term “zipper” includes non-metallic and metal zippers, locking seams, and similar means of opening and closing an opening with a flexible covering and/or sides. The term “to tension” means herein to tighten the vehicle straps (3, 3′) or buddy system straps (2, 2′) using the adjustment means so that the CBTS is adequately secured to a roof top or the cargo is adequately compressed to provide a stable load, respectively. The meaning herein of the term “adjustment means” includes any of the devices commonly known, in the art for tightening straps or webbing, e.g., buckles longitudinally moveable to adjust strap length before mating the coupler associated with a first buckle and strap with the coupler associated with a second buckle and strap, couplers longitudinally moveable to adjust strap length before mating the coupler associated with a first strap with the coupler associated with a second strap, spring-loaded tourniquet buckles, drum and clawfoot cinching devices, etc. The term “adjustable strap” means herein a strap with an associated adjustment means, preferably an adjustment means integral with the strap.

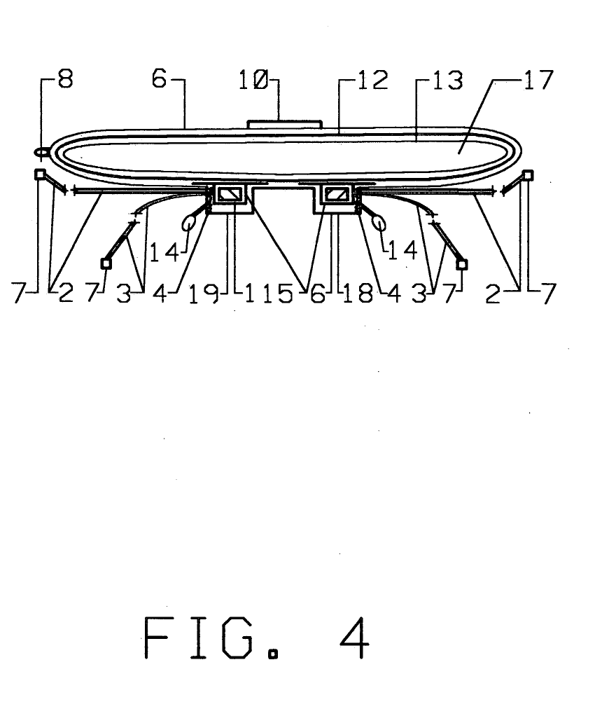

An embodiment of the CBTS for carrying and transporting sports boards is generally oblong in shape, and constructed with an exterior layer of material (6) enclosing the main compartment (17) and with an anterior zippered opening (11) for access to the main compartment. All zippers used in a CBTS are preferably nylon or other hard, durable, non-corrosive material. The exterior layer (6) is preferably made of a woven fabric rated UPF 15 or higher. With reference to FIG. 2, the CBTS can include optional upper and/or lower layers of shock absorbent material, or “cushioning” (12), such as closed cell foam, sewn into the CBTS distal from an optional interior lining (13). Each layer of cushioning (12) provides thermal insulation and protection from impact for the contents placed in the main compartment (17). The optional interior lining (13) is immediately proximal to the main compartment (17). If used in constructing the CBTS, the cushioning (12) and interior lining (13) are sewn to the exterior layer (6) and preferably extend the full length and width of the bag. If the interior lining (13) and cushioning (12) are not used in constructing the CBTS, the storage compartment (17) is bounded solely by the exterior layer (6) except for the portions of the ventral area where a soft rack or optional soft rack backing (15) is located. Ventral and distal to the areas of soft rack backing (15) are the anterior soft rack (18) and the posterior soft rack (19), as shown in FIG. 4. It is possible to construct a CBTS without use of soft rack backing (15) by bonding the exterior layer (6) directly to the soft racks (18, 19) and using portions of the vehicle strapping system straps in place of the soft rack backing, as explained below. CBTS embodiments can be constructed with more than two soft racks; heavier loads in the main compartment, or stacked CBTSs, may require the use of one or more CBTSs equipped with more than two soft racks. Preferably integral with the anterior soft rack (18) and the posterior soft rack (19) are four built-in zippered pockets (4) (two anterior and two posterior pockets on each side of the CBTS) for storing the vehicle strapping system (3), the optional “buddy system” straps (2), and the optional universal clips (14). The zippered pockets (4) can alternatively be constructed as zippered pockets in the exterior layer (6).

The vehicle strapping system comprises an adjustable strap (3) attached at or near one lateral edge of an anterior soft rack (18) on a CBTS, and a counterpart strap (3′) attached at or near the other lateral edge of such anterior soft rack (18); the counterpart strap (3′) is optionally adjustable. A second adjustable strap (3) and optionally adjustable counterpart strap (3′) is attached in the same fashion at or near the lateral edges of a posterior soft rack (19). The optional buddy system comprises an adjustable strap (2) attached at or near one lateral edge of an anterior soft rack (18) on a CBTS, and a counterpart strap (2′) attached at or near the other lateral edge of such anterior soft rack (18); the counterpart strap (2′) is optionally adjustable. Each strap (3, 3′) of the vehicle strapping system and each strap (2, 2′) of the optional buddy system terminates (a) preferably in a male or female coupler (male coupler on one strap (2 or 3), and female on the counterpart strap (2′ or 3′), or vice versa as to gender of couplers) or (b) on one strap in a cinching system known in the art (e.g., drum and claw foot, spring-loaded tourniquet) that combines both adjustment and coupling functions, with the counterpart strap terminated plainly or otherwise as needed to work with the cinching system. The buddy system straps can be used as (a) load compression straps (also known as “top straps”) on a single CBTS, i.e., each mating pairof buddy system straps is routed over the dorsal exterior surface of the container body and adjusted to compress the load within the CBTS main compartment, or (b) as load compressions straps (also known as “buddy straps”) to attach and compress one or more cargo bags stacked on top of, or beside, a first CBTS. The use as buddy straps is addressed in more detail below.

Additional cargo bags can also be attached to a first CBTS using the optional universal clipping system. The universal clipping system essentially comprises a carabiner or similar fastener (14) that is attached to a strong, flexible material (20), preferably webbing, that is in turn attached at or near each lateral edge of each soft rack. In a preferred embodiment of the universal clipping system, a carabiner or similar fastener (14) is held within a loop of webbing (20); the webbing (20) extends through the exterior layer (6) and is sewn into the junction of the soft rack core (1) and the soft rack backing (15) or is otherwise bonded to the soft rack. If soft rack backing (15) is not used, a single piece of webbing (20) or similar strong, flexible material can traverse the dorsal or ventral surface of the relevant soft rack and extend through the exterior layer (6) on both sides of the container near the lateral (left and right) ends of the soft rack, the webbing (20) is bonded to the soft rack (in the portion that traverses the soft rack) and holds a universal clip (14) in a loop close to the container body and distally from the webbing's point of emergence from the exterior layer (6). The penetration of the webbing (20) through the exterior layer (6) may be through a grommet, or the opening through which the webbing penetrates the exterior layer may be sewn shut to prevent entry of foreign matter into the interior of the bag. Other means of affixing the universal clips are possible so long as they provide a strong attachment, directly or indirectly (i.e., by being bonded first to a vehicle strapping system strap or to a buddy system strap, which strap is bonded to the soft rack and/or exterior layer) to the soft rack or exterior layer, but preferably to both exterior layer and soft rack. For instance, the webbing can enclose and be bonded to the circumference of the soft rack, and/or penetrate through the long axis of the soft rack, rather then traverse across the dorsal or ventral surface of the soft rack.

The male and female couplers (7) are preferably couplers of a high strength, side release, plastic or metal buckle with integral strap length adjustment, such as those available from American Cord and Webbing (www.acw1.com/side.html). American Cord and Webbing is also a typical source of webbing and straps suitable for use in the CBTS.

One end of each vehicle strap (3, 3′) and buddy system strap (2, 2′), called the “fixed end”, is attached directly or indirectly (i.e., by being bonded first to the other type of strap or to universal clip webbing, which strap or webbing is bonded to the soft rack and/or exterior layer) to the exterior layer or soft rack (but preferably to both) at or near the relevant lateral edge of a soft rack. In the case of “indirect bonding”, such straps can be attached to the universal clip webbing (20), which webbing (20) is then attached to the exterior layer and/or soft rack, but preferably to both exterior layer and soft rack. Another type of indirect bonding is to bond a strap or webbing to the soft rack, and the soft rack is then bonded to the exterior layer and to a different strap or webbing traversing the soft rack. Yet another type of indirect bonding is to bond a strap or webbing to the exterior layer near the lateral edge of a soft rack, and the exterior layer is then bonded to the soft rack and to a different strap or webbing traversing the soft rack.

The vehicle strapping system straps can be bonded to the soft rack in one of the ways described above for bonding of the universal clip webbing to a soft rack (e.g., traversing the dorsal, ventral, or medial portions of the soft rack from one side of the container body to the other side of the container body). Using the vehicle strapping system straps to traverse a soft rack is the best mode for carrying out the invention, since the vehicle strapping system normally bears the greatest stress, compared with the universal clip webbing and the buddy system straps, and there are fewer points of failure if the vehicle strapping system straps are bonded directly to the exterior layer and to the soft rack. In this design, the universal clip webbing can be attached at or near a lateral edge of a soft rack to the vehicle straps (or buddy system straps, as the case may be) that traverse the soft rack. In the simplest embodiment of a CBTS with universal clips, universal clip webbing is not used and the universal clips are disposed in a loop of the vehicle strapping system straps (near the point of entry of the straps into the container body) that traverse the anterior and posterior soft racks; each universal clip (14) can be fixed in place within its respective loop, e.g., by a knot or by small strap across the loop and sewn to the larger straps (2, 2′, 3, 3′). One end of each optional buddy system straps is preferably attached to the vehicle straps or to the universal clip webbing at or near a lateral edge of the associated soft rack. Alternatively, in embodiments of the cargo bag designed for heavy loads, both the vehicle straps and the universal clip webbing and/or the buddy system straps can be attached to a soft rack in one of the ways described above for bonding of the universal clip webbing to a soft rack (e.g., traversing the dorsal, ventral, or medial portions of the soft rack from one side of the container body to the other side of the container body). The juncture of the vehicle straps (3, 3′), optional buddy system straps (2, 2′), and/or the universal clip webbing (20) that is at or near the lateral edge of a soft rack can be reinforced with riveting, adhesive, sewing, welding, or a combination of such techniques. Methods of bonding of straps and webbing to a soft rack also include equivalents thereof, such as bonding of the straps to the exterior layer in the region of a soft rack, and bonding the soft rack to the exterior layer (6) in a manner that effectively secures the CBTS to the vehicle and immobilizes the soft racks on the vehicle roof after the vehicle straps are routed through the passenger cabin and tensioned. In embodiments in which universal clips (20) are used with universal clip webbing (20), the universal clips (14) are preferably attached to the free ends of the webbing by looping the webbing around the clip and sewing the tail end of the webbing to a point on the webbing between the clip and the entry of the webbing to the exterior layer.

The vehicle straps (3, 3′), universal clips (14), and buddy system straps (2, 2′) are preferably stored in a zippered storage compartment (4) near the entry point of the vehicle straps (3, 3′), universal clip, webbing (20), and buddy system straps (2, 2′), as the case may be, into the exterior layer near the lateral edge of a soft rack. A zippered storage compartment (4) is preferably, in part or in whole, a cavity in a soft rack near the lateral edge of the soft rack; such cavity has a flexible, zippered flap. Alternatively, a zippered storage compartment (4) is a zippered pocket sewn on, or preferably inside, the exterior layer (6) near the lateral edge of the soft rack; in either case, the storage compartment (4) has a zippered closure so that straps and webbing can be retained inside the compartment when such straps and webbing are not needed. For instance, during roof top transport, the straps, but not the clips, might be used, and the clips would remain inside the zippered storage compartment (4). Preferably, the point of entry of the vehicle straps (3, 3′), universal clip webbing (20), and buddy system straps (2, 2′) through the exterior layer (6) is inside the storage compartment (4); with the entry point so located, the vehicle straps (3, 3′) can be deployed and tensioned with the undeployed buddy straps and/or universal clips retained within the storage compartment (4).

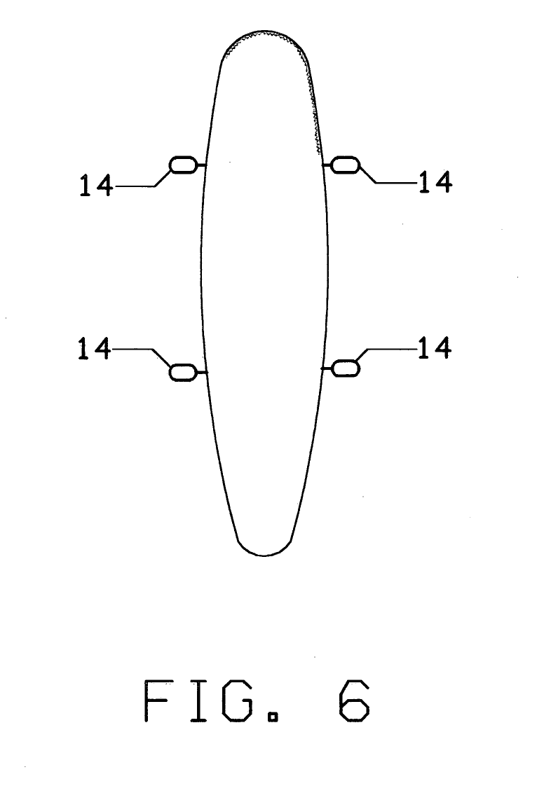

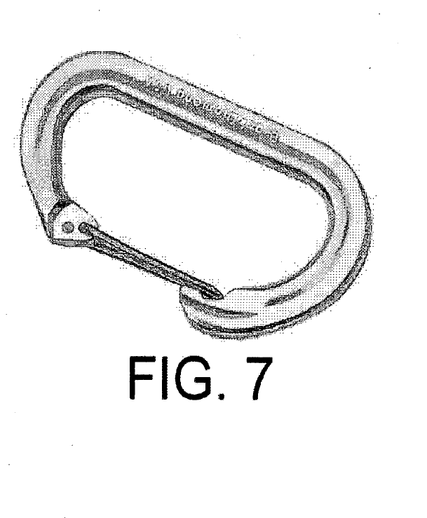

FIG. 6 shows universal clips extended from the CBTS, and FIG. 7 shows a detail of a preferred universal clip (a non-locking carabiner). Locking carabiners are also a preferred universal clip.

At a minimum, a CBTS comprises an exterior layer (6); a zippered opening (11); at least one anterior soft rack (18) bonded to the exterior layer (6) and equipped with a vehicle strapping system (3, 3′) that traverses the soft rack and is bonded to the exterior layer (6) and/or the anterior soft rack (18); and at least one posterior soft rack (19) bonded to the exterior layer (6) and equipped with a vehicle strapping system (3, 3′) that traverses the soft rack and is bonded to the exterior layer (6) and/or the posterior soft rack (19). Universal clips (14) and universal clip webbing (20), and buddy system straps (2, 2′), are desirable to enable load compression and joining other cargo bags to a first CBTS. CBTS embodiments with optional additional soft racks bonded to the ventral surface of the exterior layer (6) may optionally have a vehicle strapping system and optional universal clipping system and/or optional buddy system strapping attached to one or more such additional soft racks.

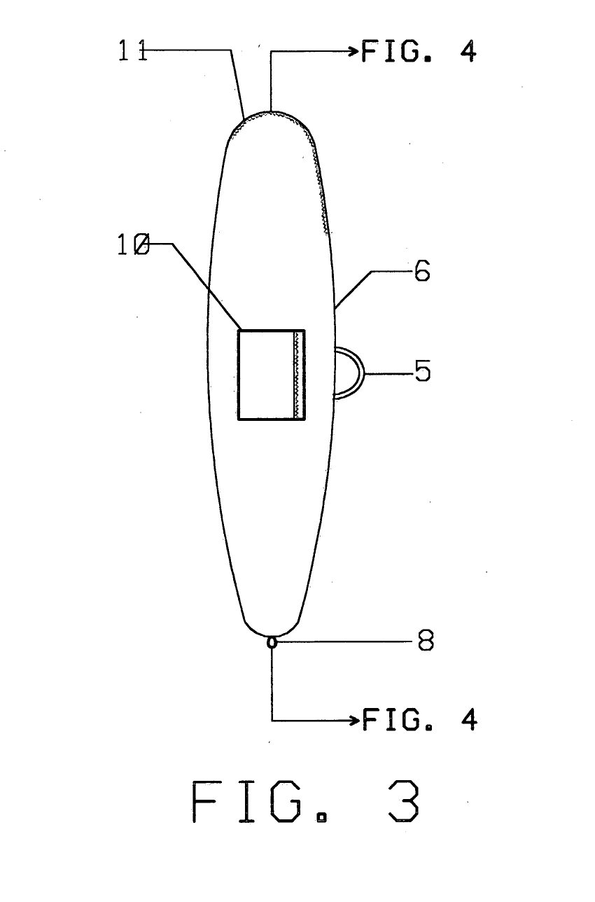

FIG. 3 shows a CBTS equipped with an optional lateral handle (5) for lifting or hand carry of a CBTS and equipped with an optional integral castered wheel (8).

FIG. 4 shows an alternative embodiment of the CBTS in which the exterior layer (6) encloses one or more associated soft racks and is bonded, over some or all of the contact area between the exterior layer and soft rack, to the one or more associated soft racks; in this embodiment, the openings of the zippered compartments (4) are placed in the exterior layer near the lateral edges of each soft rack to which straps or webbing are attached; the zippered compartments (4) may, in part or in whole, be pockets in the exterior layer or cavities in the relevant soft rack, identical to the method of construction of such zippered compartments and entry of the straps and webbing described above except for the enclosure of the soft racks by the exterior layer.

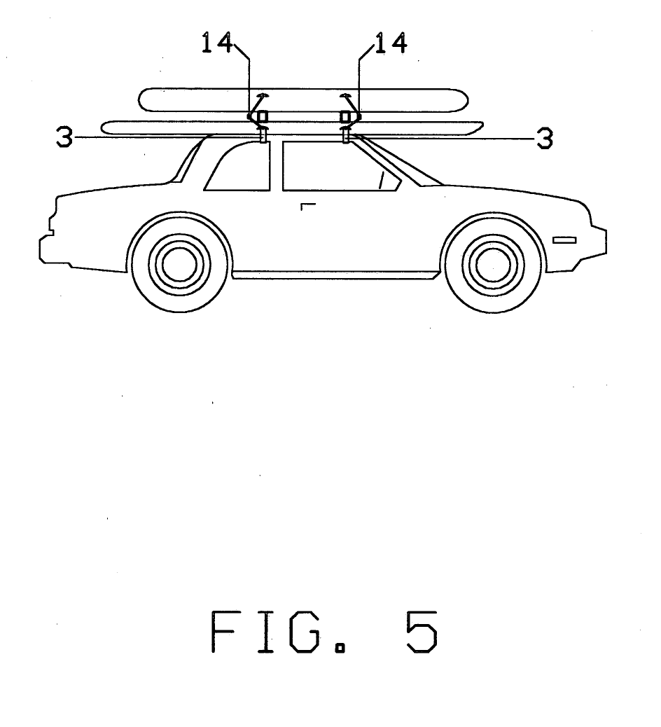

FIG. 5 shows an embodiment of a CBTS for surfboards mounted atop a sedan.

When joining multiple CBTSs in a vertical stack, e.g., for transportation or storage, the corresponding universal clips (14) of each “stacked” CBTS (i.e., anterior left to anterior left, anterior right to anterior right, posterior left to posterior left, posterior right to posterior right, universal clips of each CBTS) are fastened to each other. Additional universal clips, such as carabiners (separately acquired and not attached to webbing) can be used as links if the distance between corresponding universal clips exceeds the reach of the attached universal clips. In addition, or alternatively, two or more CBTSs may be bound together using the buddy system straps, i.e., the buddy system straps of a first CBTS are routed through the corresponding universal clips of one or more other CBTS(s) and the straps are coupled and tensioned. For additional strength, the buddy system straps (and also the vehicle straps not used to secure a CBTS to a vehicle roof) of some or all of the additional CBTSs can be routed through the universal clips of one or more other associated CBTSs, coupled, and tensioned. For additional strength of attachment to the vehicle, the vehicle straps of one or more of the CBTSs other than the CBTS closest to the vehicle roof can be routed through the passenger cabin, coupled, and tensioned.

The width (of the long axis) and length (of the short axis) of a soft rack closely correspond to the width of the associated cargo bag; the soft rack provides lateral support for items placed in the main compartment of the cargo bag. In a preferred embodiment, the bonding area between the soft rack and container body on the dorsal surface of the soft rack and ventral surface of the container body is approximately the width of the interior of the loaded main container to which the soft rack is bonded. Alternative embodiments may have soft racks somewhat wider than the container body (to distribute the cargo weight more widely on the vehicle roof) or narrower than the container body (to reduce the cost of manufacturing and volume of the CBTS when not it use). To optimize strength and weight, a soft rack is preferably built of a compressible core (1) and a more resilient shell (21). The attachment of the straps and/or universal clip webbing to the soft rack is more secure when a material, such as a relatively rigid elastomeric shell (21), is used to enable a strong bond at the areas of attachment of vehicle strapping system straps, buddy system straps, universal clip webbing, and exterior layer, as the case may be, to the soft rack. The construction of the shell (21) may be solid, hollow channel, or foam filled channel. Weight savings and stability under heavy cargo loads are achieved by using a compressible core material (1), such as a semi-rigid, closed cell polyurethane foam, enclosed at least dorsally, ventrally, and laterally by a more resilient shell (21); for greater resilience, the compressible core material (1) can be enclosed entirely in a resilient shell. Alternatively, a soft rack can be built of a single type of semi-rigid, compressible foam, such as a closed cell polyurethane foam, but this design favors attachment of the straps and webbing solely to the exterior layer (6), or to both the exterior layer (6) and to the soft rack, to reduce the risk that the straps and/or webbing will separate from the foam-only soft rack under the stress of wind loading atop a moving vehicle.

Reference numeral 1 denotes the compressible core material in a soft rack. The soft rack core (1) is preferably made of closed cell foam, or like material. The soft rack places most of the ventral surface of a first CBTS above the vehicle roof and allows a minimal amount of the soft rack or exterior layer (6) to make contact with the vehicle roof. This reduces abrasion of the vehicle roof and reduces heat transmission from the vehicle body into the main compartment of the CBTS. If a soft rack shell (21) is not part of the soft rack, the compressible core (1) comprises the entire body of the soft rack.

Reference numerals 2 and 2′ denote an optional buddy system strap, and counterpart strap, respectively, made of nylon or Dacron webbing, or similar type of high strength, lightweight, flat, flexible material, and which has a male or female clip (7) attached at the free end of each strap and counterpart strap. The fixed end of each strap is attached to a soft rack and/or exterior layer, as described above.

Reference numerals 3 and 3′ denote a vehicle strapping system strap, and counterpart strap, respectively, made of nylon or Dacron webbing, or similar type of high strength, lightweight, flat, flexible material, and which has a male or female clip (7) attached at the free end of each strap and counterpart strap. The fixed end of each strap is attached to a soft rack and/or exterior layer, as described above. The vehicle strapping system is used to attach a CBTS to a vehicle, as described herein.

Reference numeral 4, denotes a zippered compartment for storing strapping and universal clips. Each soft rack with attached strapping and universal clip has a zippered compartment near the left and right lateral edges of the soft rack.

Reference numeral 5 denotes an optional carrying handle, which is typically made of nylon webbing or cord, or like material.

Reference numeral 6 denotes an exterior layer, which is preferably made of nylon, Dacron, or like material, rated UPF 15 or higher. An example of this material is DuPont® SOLAR MAX® Nylon as supplied by Glaser Mills, Inc. of Great Neck, N.Y.

Reference numeral 7, denotes male/female clips, which are high strength, side release plastic or metal couplers that are attached to the free end of each vehicle strap (3, 3′) and optional buddy system strap (2, 2′) in order to fasten the free end of a strap (2, 3) to the free end of its counterpart strap (2′, 3′).

Reference numeral 8 denotes an optional wheel, made of rubber, polyurethane, or the like, that is attached to the container body in or near the most posterior portion of the container body, and when used with handle (9), enables a user to wheel the CBTS. The wheel (8) is preferably a castered, in-line skate wheel (commonly 70 mm to 80 mm diameter) in which the caster is bonded by rivets and/or adhesive to the most posterior margin of the CBTS. Castered wheels of other diameters and construction can be used, but larger diameter wheels typically require the addition of reinforcement material, similar to the posterior reinforcement of container body (22) described below, e.g. rigid plastic that conforms with the shape of the CBTS and is bonded to the CBTS in the posterior area of the exterior layer an d also bonded to the caster.

Reference numeral 9 denotes an optional carrying handle for pulling or hanging a CBTS, or if a CBTS is equipped with a wheel (8) or dolly, for rolling a CBTS. The handle (9) is typically made of nylon webbing or cord, or like material, and is located in the anterior, ventral area of the CBTS.

Reference numeral 10 denotes an optional accessories storage pocket that is typically made of the same material as exterior layer (6) and bonded to the container body. The accessories storage pocket (10) is typically used to store accessories, personal items, a collapsible dolly, dolly wheels, etc.

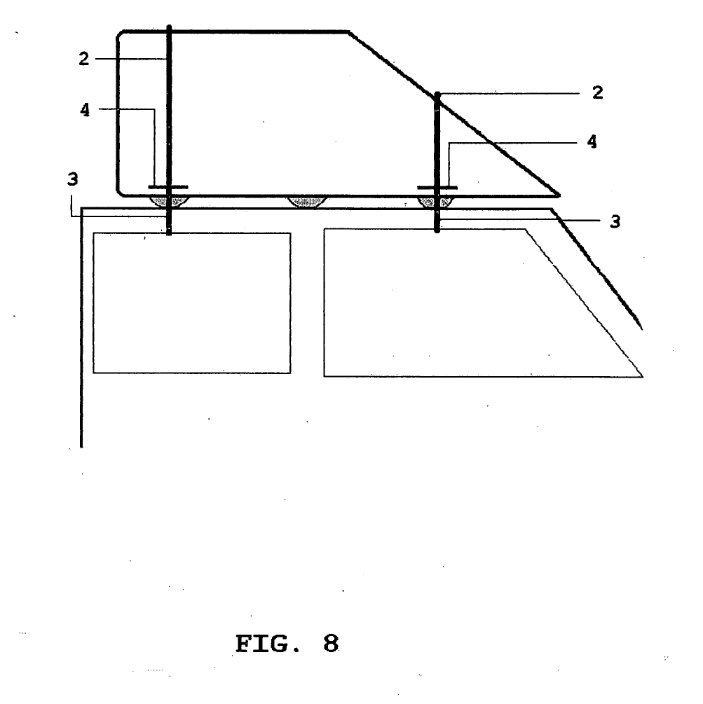

Reference numeral 11 denotes the zippered opening for access to the main compartment (17). The zipper used in the zippered opening (11) is typically made of nylon or other non-corrosive material, or the like. The opening is sized to accommodate the insertion or retrieval of cargo into the main compartment (17). In embodiments of the CBTS that have high-sided container bodies, such as the one shown in FIG. 8, the zippered opening describes a U shape, with the zipper following a U path (no zipper across the dorsal portion) to facilitate access to the main compartment when the CBTS is mounted on a vehicle roof and to prevent the zippered flap from falling on the vehicle windshield.

Reference numeral 12 denotes optional cushioning that is typically made of ¼″-½″ closed cell foam material, or the like. The cushioning (12) helps to protect the contents placed in the main compartment (17) of the CBTS from impact and thermal damage.

Reference numeral 13 denotes an optional interior lining that is typically made of lightweight polyester or like material, and is used to protect the contents placed in the main compartment (17) of the CBTS from abrasion.

Reference numeral 14 denotes a universal clip that is typically oval, aluminum, or like material, such as a carabiner (typically used as a mountain climbing accessory and available from sources such as www.BackcountryStore.com).

Reference numeral 15 denotes soft rack backing that is typically made of nylon, Dacron, or like material, and is used in a preferred embodiment to securely attach the strapping systems and vehicle strap system to the container body and to an associated soft rack. If soft rack backing (15) is used, straps (2, 2′, and optionally 3 and 3′) are bonded to the soft rack backing. The soft rack backing (15) is bonded to the exterior layer, bonded to the associated soft rack, or preferably both. In embodiments in which the universal clip webbing or vehicle strapping system strap penetrates the exterior layer (6) on one side of the container body, traverses the soft rack, and emerges from the exterior layer (6) on the other side of the container body, such strap or webbing replaces the soft rack backing (15). Using a vehicle strapping system strap bound to and traversing a soft rack instead of soft rack backing (15) usually provides a stronger attachment of the CBTS to a vehicle, but typically means that the soft rack and soft rack backing cannot be constructed and inventoried as a separate subassembly until bonding with the container body.

Reference Numeral 16 denotes an accessory storage pocket zipper, which is made of nylon, non-corrosive material or the like, for closure of an optional external storage pocket (10).

Reference Numeral 17 denotes the main compartment of the CBTS in which cargo is stored and/or transported.

Reference Numeral 18 denotes an anterior soft rack, as described above.

Reference Numeral 19 denotes a posterior soft rack, as described above.

Reference Numeral 20 denotes universal clip webbing, as described above, with which a universal clip (14) is attached to the container body.

Reference Numeral 21 denotes a soft rack shell, as described above, in soft racks that comprise a compressible core material (1) and a shell (21).

Reference Numeral 22 denotes a posterior reinforcement with dolly attachment. This reinforcement may be a resilient plastic “sock” bonded around the posterior end of the container body, a resilient planar member bonded to the posterior, ventral surface of the container body, or a resilient “shoe” bonded to a dolly or dolly attachment and affixed to the container body using the vehicle strapping system, the buddy system straps, or separately acquired straps strapped between the universal clips (14) on the posterior soft rack (19) and strap attachment fittings integral with the “shoe”. The dolly may be of various types, e.g., a dolly resembling a skateboard with fitting(s) on the dorsal surface of the board element of the “skateboard” that mate with dolly attachment fitting(s) on the ventral surface of the “sock” or “shoe” reinforcement, or a reinforcement “shoe” constructed with an integral dolly axle to which wheels are attached at the axle ends outboard of the container body. Other methods of reinforcement of the container body to enable a dolly attachment, dolly designs, and dolly attachments to the container body are known in the art, but all serve two functions: distribution of dolly stresses through reinforcement of the posterior of the container bag, and bonding or otherwise attaching a dolly or other wheeled device directly or indirectly to the reinforcement.

Reference Numeral 23 denotes a stabilization strap used with high-sided CBTSs and with CBTSs that overhang the passenger compartment. A stabilization strap is affixed at one end to a universal clip and at the other end to a point of attachment, e.g., a towing staple, on the front or back of the vehicle, as the case may be. Stabilization straps are typically used in pairs (left and right) at the front and optionally back of a vehicle.

Reference Numeral 24 denotes a strapless soft rack that is identical in construction with the anterior soft rack (18) and with the posterior soft rack (19), except it is not constructed with a vehicle strapping system, buddy system straps, or universal clip bonded to it. A strapless soft rack is bonded to the exterior layer (6), and include a shell (21) in additional to a compressible core (1).

Reference Numeral 25 denotes a terminal universal clip. The anterior and posterior points of overhanging CBTSs, such as those for kayaks, canoes, and rowing shells, can be constructed with an optional terminal universal clip, bonded via webbing to the exterior layer of the anterior and/or posterior end of the CBTS. One or more stabilization straps can be attached (or routed through) an anterior terminal universal clip and a point of attachment on the front of the vehicle. One or more stabilization straps can be attached (or routed through) a posterior terminal universal clip and a point of attachment on the back of the vehicle.

Use of the CBTS Invention. FIG. 5 shows a sports board embodiment of the CBTS, with anterior and posterior soft racks, vehicle strapping system with spring-loaded tourniquet buckles, and buddy system straps with spring-loaded tourniquet buckles, mounted on a vehicle. The method of use of this embodiment generally applies to use of all embodiments of the CBTS. The user first opens the zippered opening (11) to access the main compartment (17) and inserts one or more boards (or other cargo) into the main compartment (17), and closes the zippered opening (11). To mount a CBTS with two soft racks (anterior and posterior) and spring-loaded tourniquet buckle adjustment means on top of a vehicle, the CBTS is first placed, soft rack side down, on the vehicle's roof. The user opens the four zipper pockets for strapping system storage (4); a pocket is located on the side of each soft rack with straps. The user removes the vehicle strapping system strap (3 and 3′) from each of the four pockets. The user opens all doors of the vehicle; pulls the built-in vehicle straps (3 and 3′) into the interior of the vehicle, fastens the male coupler (7) located at the free end of one strap (3) to the female coupler (7) of located at the free end of the counterpart strap (3′) strap, opens the spring-loaded tourniquet buckle located on the strap with the adjustment means, and pulls excess strap through the buckle until a firm strap tension is achieved that will withstand wind loading of the CBTS during movement of the vehicle, and closes the buckle. To compress the load (to reduce wind resistance and noise), the user removes a buddy system strap (2) from each of the four strap storage pockets (4), pulls the buddy system straps (2 and 2′) across the top of the CBTS, fastens the male coupler (7) located at the free end of one strap (2) to the female coupler (7) of located at the free end of the counterpart strap (2′) strap, opens the spring-loaded tourniquet buckle located on the strap with the adjustment means, and pulls excess strap through the buckle until a firm strap tension is achieved that will compress and stabilize the load in the main compartment, and closes the buckle. The contents of the CBTS may be removed from the CBTS without taking the CBTS off of the vehicle (after loosening the buddy system straps). Dismounting of the CBTS from the vehicle requires execution of the same steps in reverse.

To transport a CBTS by hand, optional handle (5) is provided for hand carrying by the user. To roll the CBTS by hand, the user grips the anterior handle (9) and rolls the CBTS on built-in wheel (8). The handles (5 & 9) can also be used for lifting or hanging the CBTS.

To attach additional boards and/or bags to a CBTS with two soft racks (anterior and posterior) for hand carrying, vehicle transportation, or airline transport, without using a second CBTS, the user places the desired additional load on top of the CBTS, removes one each of the buddy system straps (2) from each of the four zippered storage pockets (4), pulls said straps over the top of the CBTS and the additional load, fastens the male/female couplers (7) together, and aEdjusts the strap to firm tension using the adjustment means.

The CBTS is constructed using different dimensions, and with different placement of the soft racks on the ventral surface of the container body, in different embodiments for different types of cargo. A CBTS for surfboards has a main compartment width that is slightly larger than the width of the widest surfboard to be transported, and a main compartment height corresponding to the number of surfboards to be transported in the CBTS. CBTSs are constructed to accommodate up to approximately seven surfboards with the skegs removed. Other CBTS embodiments are dimensioned for snowboards, wave boards, golf bags, golf bag trolleys, golf clubs, fencing, baseball, softball, lacrosse, hockey equipment, etc. CBTS embodiments for diving equipment, camping equipment, luggage, watercraft such as kayaks, canoes, and rowing shells, other sports equipment, and general cargo are dimensioned for a width no wider, and length no longer, than the roof of the vehicle on which the CBTS will be mounted. The height of a CBTS embodiment is dictated by vertical clearance of the CBTS when mounted on a vehicle and/or the stability of the loaded CBTS. As a general rule, a CBTS embodiment should be no higher than the width of the roof on which it will be mounted. The preferred surfboard CBTS embodiment is constructed with a distance of 18 inches between the anterior soft rack and the posterior soft rack (center to center). CBTS embodiments can optionally be constructed with other distances between the anterior soft rack and posterior soft rack.

As shown in FIG. 8, high-sided CBTS embodiments can be constructed with anterior and posterior surfaces dimensioned to decrease wind resistance and loading when mounted atop a moving vehicle, The primary means of wind resistance is to construct the CBTS so that the angle formed by the ventral surface of the container body of a “streamlined” CBTS and the anterior face of such container body is less than a right angle, sloping toward the rear of the vehicle when mounted on a vehicle roof. For taller CBTS embodiments, and for stacks of several CBTSs joined together, stabilization straps (23) may be installed between the anterior universal clips and a fitting on the front of the vehicle, such as the front bumper or front tow ring or staple. Optional strapless soft racks (24) are used to distribute the weight of a heavily loaded CBTS over a broader area of the vehicle roof.

To attach a second CBTS to a first CBTS for hand carrying, vehicle transportation, or airline transport, the user places the desired CBTS(s) on top of a first CBTS, removes the universal clips (14) from each of the zippered storage pockets (4), lines up the universal clips (14) on the second CBTS with the corresponding universal clips (14) on the first CBTS, and clips the universal clips together. Up to three additional CBTSs can be safely clipped to the base CBTS in this way.

All CBTS embodiments can be connected together regardless of CBTS type or contents (e.g., a snowboard CBTS can be attached to a surfboard CBTS, a wakeboard CBTS can be attached to a golf equipment CBTS).

A CBTS can also be suspended in the open bed of a pick-up truck, trailer, or similar conveyance (collectively, “truck bed”), by utilizing the truck bed's tie-down fittings (e.g., eye bolts, c-clips, d-rings, etc.). To suspend a CBTS in a truck bed, the user places the CBTS in the truck bed, removes the vehicle strapping system straps (3) from each of the zippered pockets for strapping system storage (4), loops each said strap through or around the appropriate truck bed tie-down fitting, connects the male/female couplers (7) of each strap and counterpart strap, and adjusts the straps to firm tension using the adjustment means. This form of suspended CBTS transportation limits the CBTS's contact with the bed and tailgate of the truck and allows for additional storage space beneath the CBTS in the truck bed. Additional boards and/or bags can be attached to the suspended CBTS by utilizing the buddy system strapping (2, 2′), or, alternately, additional CBTSs can be safely and securely attached to the first suspended CBTS by utilizing the universal clips (14) located in each of the zipper pockets for strapping system storage (4), as described above.

Alternately, a CBTS can be mounted on a lumber rack (a “lumber rack” is a truck bed or roof top cargo rack system for vehicles, usually pick-up trucks and mini-vans, available either factory installed or as an after-market accessory). To mount the CBTS on a lumber rack, the user places the CBTS on top of the lumber rack, removes the vehicle straps (3, 3′) from each of the zippered pockets for strapping system storage (4), loops each strap around a appropriate area of the lumber rack, fastens the male/female couplers (7), and adjusts the adjustment means to firm tension. Additional boards and/or bags can be attached to the CBTS by utilizing the buddy system strapping (2, 2′). Additional CBTSs can be safely and securely attached to the first CBTS by utilizing the universal clips (14) located in each of the zippered pockets for strapping system storage (4).

Depending on the width of a vehicle roof, two CBTSs can be mounted on the roof side by side. These side-by-side CBTSs can also serve as base CBTSs for CBTSs stacked, and joined, vertically atop each of the first two CBTSs. Each medial universal clip in the CBTSs in one stack can be joined to the most proximal medial universal clip in the parallel stack. To mount CBTSs side by side, place the first two CBTSs on the vehicle roof side-by-side. Remove the universal clips (14) from each CBTS's zippered pockets for strapping system storage (4). Clip together the four exposed medial, universal clips (two from each CBTS) to join the side-by-side CBTSs. The first two CBTSs can then be secured to the roof of the vehicle by removing the built-in vehicle straps (3) located on the lateral exterior side zippered pocket for strapping system, storage (4) of each CBTS, opening the vehicle's driver doors; pulling the built-in vehicle straps (3, 3′) into the interior of the vehicle, fastening the male/female couplers (7) at the end of the straps, and adjusting the strap using the adjustment means to firm tension. The first two CBTSs are now secure on the vehicle roof.

Additional CBTSs can then also be secured on top of the first two CBTSs by placing one or more additional CBTSs on top of the first CBTSs previously mounted, removing the medial universal clips (14) (for CBTS with anterior and posterior soft racks, two from each parallel CBTS on the same layer in the stack of CBTSs) from the zippered pockets for strapping system storage (4) and clip the corresponding universal clips together, removing the buddy system straps (2, 2′) from the four zippered pocket for strapping system storage (4) on the lateral sides of the first CBTSs already mounted on the vehicle, placing the buddy system straps over the stacked CBTSs (optionally running the buddy system straps through the universal clips closest to the vehicles sides, i.e., not the medial universal clips), fastening the male/female couplers (7), and adjusting the strap using the adjustment means to firm tension.. The four CBTSs are now secure on the vehicle.

There is a practical limit to how many layers of CBTSs can be stacked in this fashion, depending on whether the CBTS are all of the same type, (e.g., surfboard or camping equipment), the size of the main compartments, and particularly on whether there is any odd-shaped cargo or mixture of long and short length CBTSs. It is not safe to stack CBTSs if the cargo is odd-shaped or there is a mixture of long and short length CBTSs. It is safer to stack CBTSs with the same distance between soft racks so that the universal clips match, and the downward loading through the soft racks is in a straight line.

The exterior layer (6), straps (2, 2′, 3, 3′), webbing (20), and various pockets of any embodiment of the CBTS can be manufactured with DuPont® Kevlar®, metallic, or other cut-resistant yam to deter theft of the CBTS or its contents. For additional security, the zippers and/or couplers used in the CBTS can be metallic and include integral rings or staples for use with padlocks and/or cable locks.

The CBTS addresses and solves the long-standing deficiencies in the existing art. Using the different embodiments of the CBTS, various types of cargo, especially sports boards, can be safely stored or transported by hand, vehicle, or air without the purchase of, or need to attach, any additional equipment. Use of an attachable dolly permits movement of very heavily loaded CBTSs.

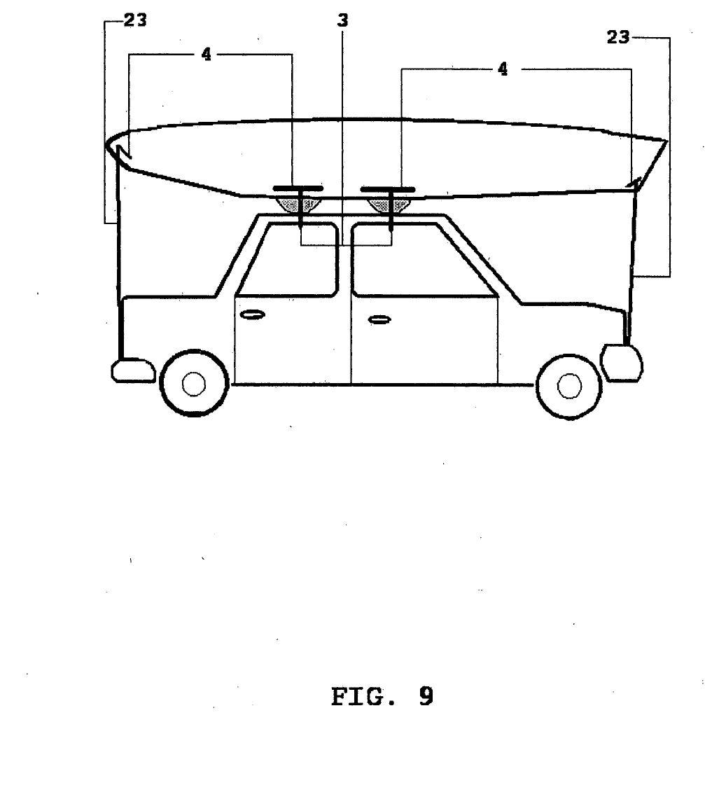

FIG. 9 shows a CBTS dimensioned for a kayak, canoe, or rowing shell. To stabilize the portion of the CBTS that overhangs the passenger cabin of the vehicle, stabilization straps (23) and terminal universal clips (25) are used front and back. Strapless soft racks (24) are also used to distribute the heavy load over a greater part of the vehicle roof.

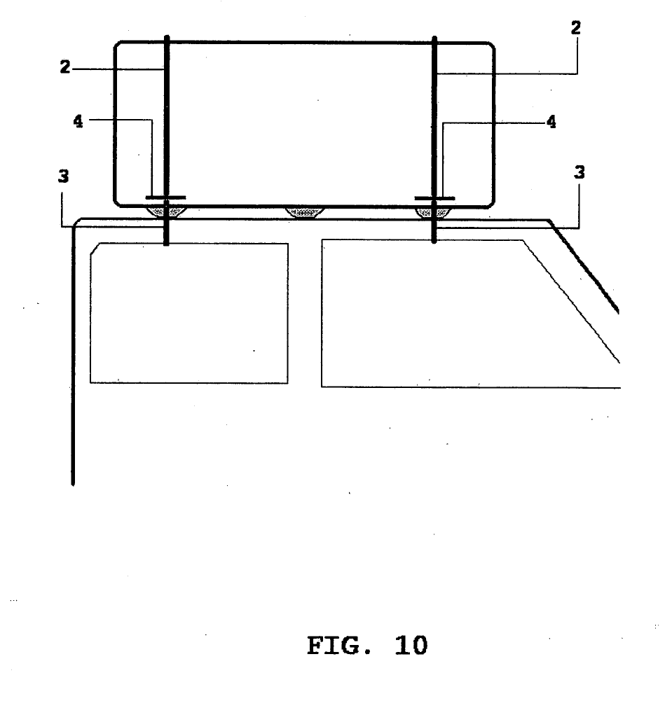

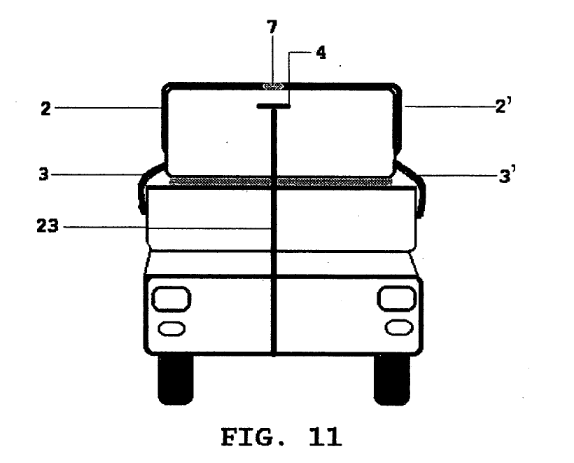

FIGS. 10 and 11 show a side view (FIG. 10) and front view (FIG. 11) of a high-sided CBTS, with stabilization straps, mounted on a vehicle roof This CBTS has minimal streamlining and is designed for maximum cargo area, for instance, for use in moving furniture or other bulky items.

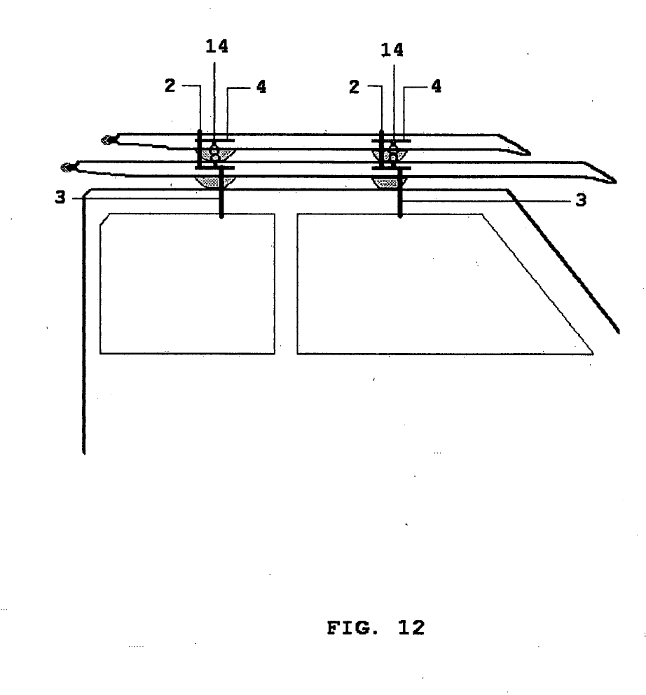

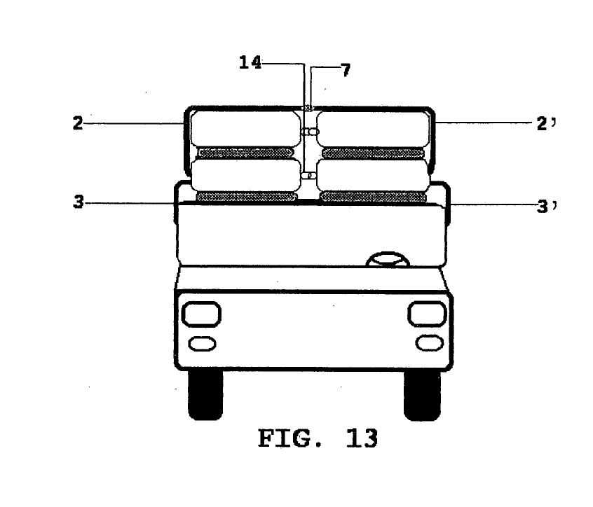

FIGS. 12 and 13 show a side view (FIG. 12) and front view (FIG. 13) of four stacked CBTSs, mounted on a roof top, with two layers of two (side-by-side) CBTS per layer. Buddy system straps (2, 2′) are used to compress the load, and the universal clips are engaged to join the side-by-side units.

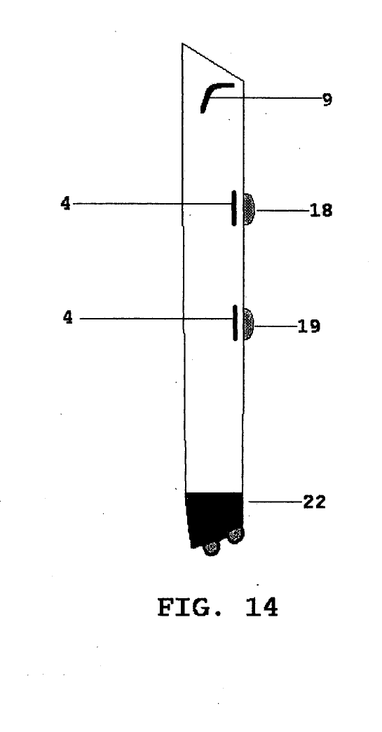

FIG. 14 shows a side view of a CBTS with a dolly attachment on a kayak CBTS.

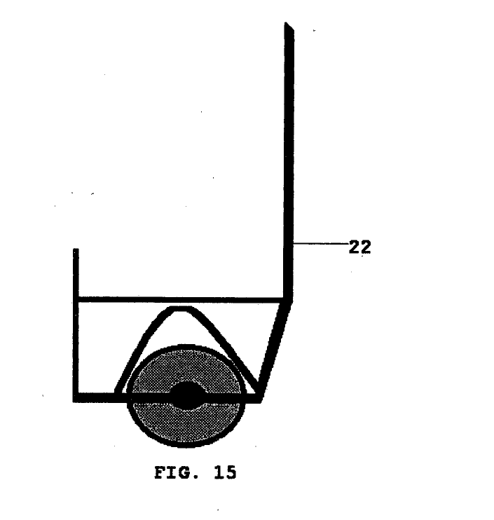

FIG. 15 shows a detail view of the “shoe” type dolly bonded to the CBTS posterior point.

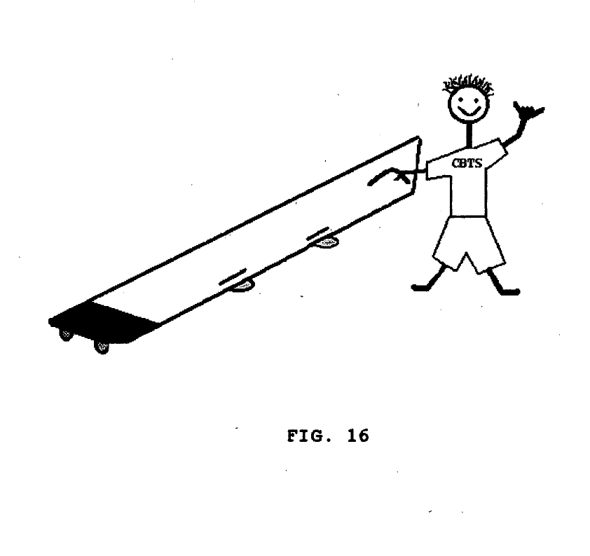

FIG. 16 shows a single user wheeling, using the dolly attachment shown in FIG. 15, a kayak CBTS on the ground.

Although the above description contains many specifics, these should not be construed as limiting the scope of the invention, but as merely providing illustrations of some of the presently preferred embodiments of this invention. The scope of the invention should be determined by the appended claims and their equivalents, rather than by the examples given.

We claim:

1. A container comprising an exterior layer; a zippered opening to a main compartment of the container, which main compartment is bounded by the exterior layer; at least one anterior soft rack bonded to the exterior layer and equipped with a vehicle strapping system, the fixed ends of which vehicle strapping system straps are bonded directly or indirectly to the exterior layer and to the anterior soft rack; and at least one posterior soft rack bonded to the exterior layer and equipped with a vehicle strapping system, the fixed ends of which vehicle strapping system straps are bonded directly or indirectly to the exterior layer and to the posterior soft rack.

2. A container comprising an exterior layer; a zippered opening to a main compartment of the container, which main compartment is bounded by the exterior layer; at least one anterior soft rack bonded to the exterior layer and equipped with a vehicle strapping system that traverses the anterior soft rack, the fixed ends of which vehicle strapping system straps are bonded directly or indirectly to the exterior layer and to the anterior soft rack; and at least one posterior soft rack bonded to the exterior layer and equipped with a vehicle strapping system that traverses the posterior soft rack, the fixed ends of which vehicle strapping system straps are bonded directly or indirectly to the exterior layer and to the posterior soft rack.

3. A container comprising an exterior layer; a zippered opening to a main compartment of the container, which main compartment is bounded by the exterior layer; at least one anterior soft rack bonded to the exterior layer and equipped with (a) a vehicle strapping system, the fixed ends of which vehicle strapping system straps are bonded directly or indirectly to the exterior layer and to the anterior soft rack, and (b) buddy system straps, the fixed ends of which straps are bonded directly or indirectly to the exterior layer and to the anterior soft rack; and at least one posterior soft rack bonded to the exterior layer and equipped with (i) a vehicle strapping system, the fixed ends of which vehicle strapping system straps are bonded directly or indirectly to the exterior layer and to the posterior soft rack, and (ii) buddy system straps, the fixed ends of which straps are bonded directly or indirectly to the exterior layer and to the posterior soft rack.

4. A container comprising an exterior layer; a zippered opening to a main compartment of the container, which main compartment is bounded by the exterior layer; at least one anterior soft rack bonded to the exterior layer and equipped with (a) a vehicle strapping system, the fixed ends of which vehicle strapping system straps are bonded directly or indirectly to the exterior layer and to the anterior soft rack, (b) buddy system straps, the fixed ends of which are bonded directly or indirectly to the exterior layer and to the anterior soft rack, and (c) universal clips, each affixed to webbing or a strap that is bonded directly or indirectly to the exterior layer and to the anterior soft rack; and at least one posterior soft rack bonded to the exterior layer and equipped with (i) a vehicle strapping system, the fixed ends of which vehicle strapping system straps are bonded directly or indirectly to the exterior layer and to the posterior soft rack, (ii) buddy system straps, the fixed ends of which are bonded directly or indirectly to the exterior layer and to the posterior soft rack, and (iii) universal clips, each affixed to webbing or a strap that is bonded directly or indirectly to the exterior layer and to the posterior soft rack.

5. The container of claim 1, 2, 3, or 4, wherein at least one of each type of strap (vehicle strapping system straps in claims 1, 2, 3, or 4, and buddy system straps in claims 3 and 4) associated with a soft rack has an adjustment means selected from the group comprising (a) buckles longitudinally moveable to adjust strap length before mating the coupler associated with a first buckle and strap with the coupler associated with a second buckle and strap, (b) couplers longitudinally moveable to adjust strap length before mating the coupler associated with a first strap with the coupler associated with a second strap, (c) spring-loaded tourniquet buckles, and (d) drum and clawfoot cinching devices, and wherein each free end of each strap with adjustment means is terminated in a coupler that mates with a coupler on the free end of the counterpart strap for each such strap with adjustment means.

6. The container of claim 1, 2, 3, or 4, wherein the exterior layer is made of woven material rated UPF 15 or higher.

7. The container of claim 1, 2, 3, or 4, wherein the vehicle strapping system straps are stored in zippered compartments on the container when not in use.

8. The container of claim 3 or 4, wherein the vehicle strapping system straps and buddy system straps are stored in zippered compartments on the container when not in use.

9. The container of claim 4, wherein the vehicle strapping system straps, buddy system straps, and universal clips are. stored in zippered compartments on the container when not in use.

10. The container of claim 1, 2, 3, or 4, wherein at least one handle is bonded to the container.

11. The container of claim 1, 2, 3, or 4, wherein at least one zippered accessory storage compartment is bonded to the container.

12. The container of claim 1, 2, 3, or 4, wherein at least one layer of interior lining is installed proximal to the interior surface of the exterior layer.

13. The container of claim 12, wherein a layer of cushioning is installed between the interior lining and the exterior layer.

14. The container of claim 1, 2, 3, or 4, wherein each soft rack comprises a semi-rigid, closed cell foam.

15. The container of claim 14, wherein the semi-rigid, closed cell foam is enclosed at least dorsally, ventrally, and laterally by a shell, and optionally entirely enclosed by a shell.

16. The container of claim 1, 2, 3, or 4, wherein at least one castered wheel is installed on the posterior margin of the container.

17. The container of claim 1, 2, 3, or 4, wherein posterior reinforcement with dolly attachment is installed on the posterior of the container.

18. The container of claim 1, 2, 3, or 4, wherein the container dimensions are sized for one or more sport boards selected from the group comprising surfboards, snowboards, snow skis, water skis, wake boards, wind surfboards, and kite surfboards.

19. The container of claim 1, 2, 3, or 4, wherein the container dimensions are sized for watercraft selected from the group comprising kayaks, canoes, and rowing shells.

20. The container of claim 1, 2, 3, or 4, wherein the container dimensions are sized for golf bags and golf bag trolleys.

21. The container of claim 1, 2, 3, or 4, wherein the container dimensions are sized for one or more stick sports selected from the group comprising golf, hockey, baseball, softball, lacrosse, and fencing.

22. The container of claim 1, 2, 3, or 4, wherein the container dimensions are sized for cargo selected from the group comprising diving equipment, camping equipment, luggage, and boxed goods.

23. The container of claim 1, 2, 3, or 4, wherein the container dimensions are sized to reduce wind resistance when the container is mounted on a vehicle roof.

24. The container of claim 1, 2, 3, or 4, wherein at least the exterior layer, and optionally other woven portions of the container, are manufactured with cut-resistant yarn to deter theft of the container or its contents.

25. The container of claim 1, 2, 3, or 4, wherein the zippers, and optionally other types of closures, are metallic and include integral rings or staples for use with padlocks or cable locks.
